(19) United States
(12) Patent Application Publication
(10) Pub. No.: US 2016/0066222 A1
(43) Pub. Date: Mar. 3, 2016

(54) MULTI-CONNECTIVITY IN A WIRELESS NETWORK

(71) Applicant: Nokia Solutions and Networks Oy, Espoo (FI)

(72) Inventors: Jarmo Tapani MAKINEN, Espoo (FI); Yang LIU, Beijing (CN); Mikko SAILY, Laukkoski (FI)

(21) Appl. No.: 14/475,388

(22) Filed: Sep. 2, 2014

(51) Int. Cl. H04W 36/00; H04W 36/22; H04W 74/00

(52) U.S. Cl. CPC H04W 36/0027; H04W 36/0066; H04W 74/006; H04W 36/22

(57) ABSTRACT

An example technique may include establishing a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell, controlling sending, by the user device to the first cell, a request to receive a first group of data units of the multiple connection session, and controlling sending, by the user device to the second cell, a request to receive a second group of data units of the multiple connection session, wherein the first group of data units is different than the second group of data units.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments.

### SUMMARY

According to an example implementation, a method may include establishing a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell, controlling sending, by the user device to the first cell, a request to receive a first group of data units of the multiple connection session from the first cell, and controlling sending, by the user device to the second cell, a request to receive a second group of data units of the multiple connection session from the second cell, wherein the first group of data units is different than the second group of data units.

According to an example implementation, an apparatus may include at least one processor and at least one memory including computer instructions, when executed by the at least one processor, cause the apparatus to: establish a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell, control sending, by the user device to the first cell, a request to receive a first group of data units of the multiple connection session, and control sending, by the user device to the second cell, a request to receive a second group of data units of the multiple connection session, wherein the first group of data units is different than the second group of data units.

According to another example implementation, a computer program product includes a computer-readable storage medium and storing executable code that, when executed by at least one data processing apparatus, is configured to cause the at least one data processing apparatus to perform a method including: establishing a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell, controlling sending, by the user device to the first cell, a request to receive a first group of data units of the multiple connection session from the first cell, and controlling sending, by the user device to the second cell, a request to receive a second group of data units of the multiple connection session from the second cell, wherein the first group of data units is different than the second group of data units.

According to an example implementation, an apparatus may include means for establishing a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell, means for controlling sending, by the user device to the first cell, a request to receive a first group of data units of the multiple connection session from the first cell, and means for controlling sending, by the user device to the second cell, a request to receive a second group of data units of the multiple connection session from the second cell, wherein the first group of data units is different than the second group of data units.

According to another example implementation, a method may include establishing, by a multiple connection entity of a core network, a multiple connection session between the multiple connection entity and a user device in a wireless network, the multiple connection session including at least a first connection between the user device and the multiple connection entity via a first cell and a second connection between the user device and the multiple connection session via a second cell, wherein the first connection and the second connection are independent, controlling receiving, by the multiple connection entity, a plurality of downlink data units of the multiple connection session, providing, by the multiple connection entity, a multiple connection session sequence number for each downlink data unit of the multiple connection session, and sending, by the multiple connection entity, a copy of a plurality of the downlink data units of the multiple connection session to both the first cell and the second cell.

According to an example implementation, an apparatus may include at least one processor and at least one memory including computer instructions, when executed by the at least one processor, cause the apparatus to: establish, by a multiple connection entity of a core network, a multiple connection session between the multiple connection entity and a user device in a wireless network, the multiple connection session including at least a first connection between the user device and the multiple connection entity via a first cell and a second connection between the user device and the multiple connection session via a second cell, wherein the first connection and the second connection are independent, control receiving, by the multiple connection entity, a plurality of downlink data units of the multiple connection session, provide, by the multiple connection entity, a multiple connection session sequence number for each downlink data unit of the multiple connection session, and control sending, by the multiple connection entity, a copy of a plurality of the downlink data units of the multiple connection session to both the first cell and the second cell.

According to another example implementation, a computer program product includes a computer-readable storage medium and storing executable code that, when executed by at least one data processing apparatus, is configured to cause the at least one data processing apparatus to perform a method including: establishing, by a multiple connection entity of a core network, a multiple connection session between the multiple connection entity and a user device in a wireless network, the multiple connection session including at least a first connection between the user device and the multiple connection entity via a first cell and a second connection between the user device and the multiple connection session via a second cell, wherein the first connection and the second connection are independent, controlling receiving, by the multiple connection entity, a plurality of downlink data units of the multiple connection session, providing, by the multiple connection entity, a multiple connection session sequence number for each downlink data unit of the multiple connection session, and sending, by the multiple connection entity, a copy of a plurality of the downlink data units of the multiple connection session to both the first cell and the second cell.

According to another example implementation, an apparatus may include means for establishing, by a multiple connection entity of a core network, a multiple connection session between the multiple connection entity and a user device in a wireless network, the multiple connection session including at least a first connection between the user device and the multiple connection entity via a first cell and a second connection between the user device and the multiple connection session via a second cell, wherein the first connection and the second connection are independent, means for controlling receiving, by the multiple connection entity, a plurality of downlink data units of the multiple connection session, providing, by the multiple connection entity, a multiple connection session sequence number for each downlink data unit of the multiple connection session, and means for sending, by the multiple connection entity, a copy of a plurality of the downlink data units of the multiple connection session to both the first cell and the second cell.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network 130 according to an example implementation.

FIG. 2 is a diagram illustrating an example implementation of a user device and a core network in which multiple connectivity may be provided for the user device.

FIG. 3 is a flow chart illustrating operation of a user device according to an example implementation.

FIG. 4 is a flow chart illustrating operation of a multiple connection anchor at a core network according to an example implementation.

FIG. 5 is a block diagram of a wireless station (e.g., BS or user device) 500 according to an example implementation.

### DETAILED DESCRIPTION

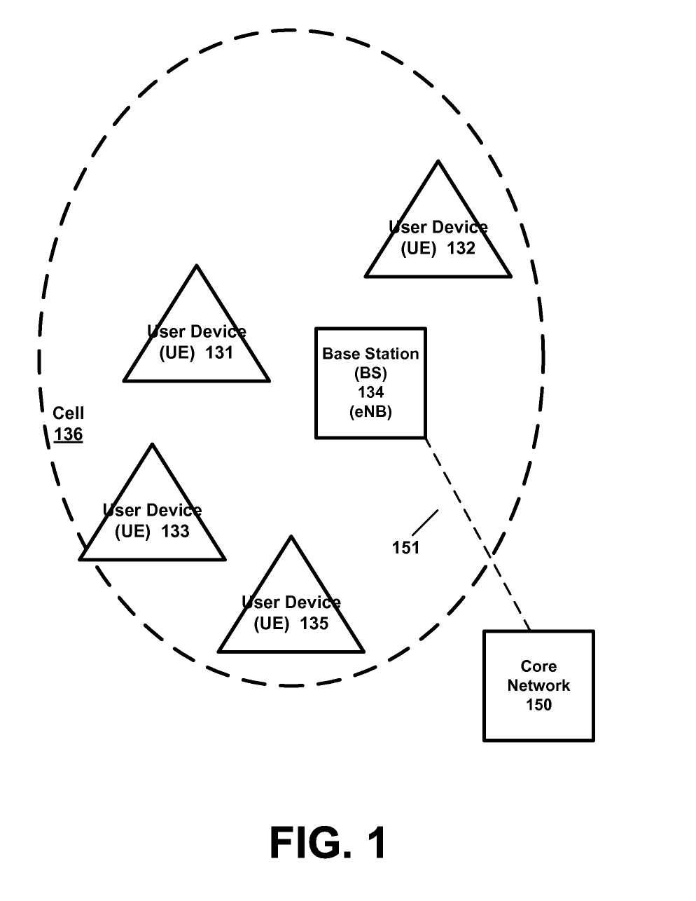

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an enhanced Node B (eNB). At least part of the functionalities of a base station or (e)Node B may be also be carried out by any node, server or host which may be operably coupled to a transceiver, such as a remote radio head. BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

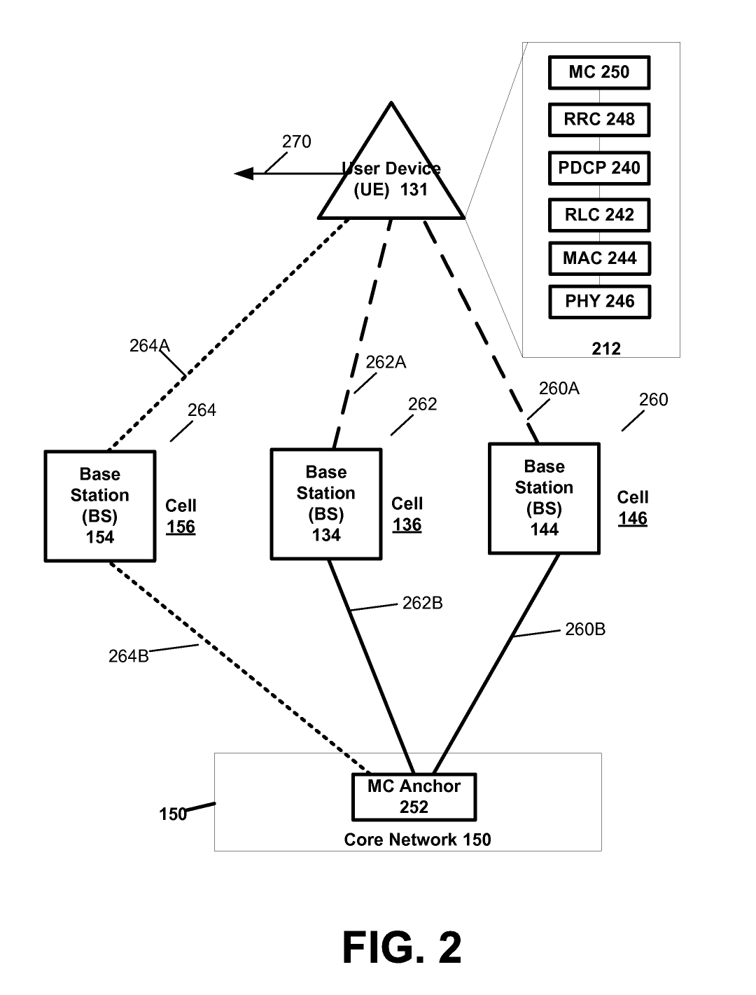

FIG. 2 is a diagram illustrating an example implementation of a user device and a core network in which multiple connectivity (e.g., dual connectivity) may be provided for the user device. According to an example implementation, multiple connectivity (or multi-connectivity) may be provided as a multiple connection (MC) session wherein data is communicated between a user device 131 and core network 150 via two or more independent connections, including independent wireless connections. Also, according to an example implementation, each connection (or a plurality of connections) of the MC session may be provided between the user device 131 and the core network 150 via different cells.

Referring to FIG. 2, example user device 131 may include at least one radio protocol stack 212 that may be implemented in hardware and/or software. According to an example implementation, a protocol stack may include logic, and/or computer instructions executed by a processor to perform the functions or operations for each entity of the protocol stack. An example protocol stack 212 for a user device 131 may include, for example, a Multiple Connection (MC) entity 250, a Packet Data Convergence Protocol (PDCP) entity 240, a Radio Link Control (RLC) entity 242, a Media Access Control (MAC) entity 244, a Physical layer (PHY) entity 246, and a Radio Resource Control (RRC) entity 248.

The PDCP entity 240 may, for example, perform ciphering (encryption and decryption of data) and header compression-decompression. The RLC entity 242 may, for example, perform segmentation/concatenation, error detection and correction, data retransmission, duplicate detection and in-sequence data delivery to higher layers. According to an example implementation, there may be one RLC corresponding to one logical channel. MAC entity 244 performs multiplexing of logical channels (where there may be one or more logical channels), hybrid ARQ (HARD) retransmissions (where ARQ may refer to automatic repeat request), inserting of MAC control elements (MAC CEs) used for in-band control signaling, and other MAC-related functions. The PHY entity 246 handles or performs coding/decoding, modulation/demodulation, multi-antenna mapping, and other physical layer functions. Multiple RLC entities within a user device may share one MAC entity 244 and one PHY entity 246. RRC entity 248 may be responsible for handling a number of functions or procedures related to the Radio Access Network (RAN).

Referring again to the example radio protocol stack 212 of user device 131, the MC entity 250 may, for example, perform user device functions associated with establishing, management and/or control of one or more multiple connection (MC) sessions that may be established between user device 131 and core network 150. As noted, a multiple connection session may include a session wherein data is communicated between user device 210 and core network 150 via two or more independent connections, including two or more independent wireless connections. The data transmitted within the MC session may be for one application running on the user device 131, or may include data for multiple applications (e.g., voice data, text data from a text/messaging application, data from a web browser, . . . ) running on the user device.

According to an example implementation, user device 131 may include a radio protocol stack 212 for each independent connection or each independent wireless connection. Also, one MC entity 250 may be shared among multiple connections for a MC session. The multiple independent wireless connections for a MC session may be provided for the same radio access technology (RAT), or among different RATs (e.g., LTE, wireless LAN/WLAN, 3G, EDGE, . . . ). In some cases, a MAC entity 244 and a PHY entity 246 may be shared among multiple independent wireless connections for a MC session where the wireless connections are for the same RAT.

As shown in the illustrative example of FIG. 2, a user device 131 may be coupled to a core network 150 via a plurality of cells, including, for example, via a cell 136 that is provided by BS 134, and a cell 146 that is provided by BS 144. In this example, a third cell, cell 156 provided by BS 156, is also shown in FIG. 2, e.g., to allow the user device 131 to perform a handover (or cell reselection) from cell 146 to cell 156 as the user device 131 moves towards cell 156/BS 154, shown by arrow 270. A decision for user device 131 to perform a handover or cell reselection from a first cell to a second cell may be determined by either the user device 131 or core network 150.

Thus, in this example shown in FIG. 2, user device 131 may be coupled to core network 150 via two independent connections, where each connection may include: an independent wireless connection between the user device 131 and a cell, and a backhaul connection between the cell and the core network 150. For example, as shown in FIG. 2, a MC session may be established including multiple connections between user device 131 and core network 150, including a connection 260 provided via cell 146, which includes wireless connection 260A and backhaul connection 260B, and a connection 262 provided via cell 136, which includes a wireless connection 262A and a backhaul connection 262B. In this illustrative example, the MC session includes only two connections, but any number of connections may be provided as part of a MC session.

The wireless connections 260A and 262A may be considered to be independent wireless connections because each of the wireless connections are managed separately by the user device 131 or by core network 150, and a failure (or break) or disconnection of any of the wireless connections of the MC session does not cause (or result in) a failure or disconnection of any other wireless connections of the MC session. Thus, for example, as independent wireless connections, a failure or disconnection of wireless connection 260A does not cause a failure or disconnection to wireless connection 262A, and a failure or disconnection of wireless connection 262A does not cause a failure or disconnection to wireless connection 260A. This is in contrast to a use of a primary cell (Pcell) and a secondary cell (Scell), where a failure or disconnection of a connection established via the Pcell will cause a disconnection of the connection established via the Scell.

According to an example implementation, due to independent connections (e.g., including independent wireless connections), in the event of a failure or a disconnection of one of the connections of the MC session, all of the data for the MC session may be communicated between the user device 131 and core network 150 via the other remaining connection(s)/cell(s) of the MC session, while the user device re-establishes a new connection to replace the failed/disconnected connection for the MC session, for example. Similarly, in the event that the user device performs a handover for one of the connections of the MC session, all of the data for the MC session may be communicated via the one or more other connections/cells of the MC session during such handover procedure, until a new connection is established and added to the MC session, for example. In this manner, one or more of the example implementations may assist in providing improved connection robustness and may be more likely to result in an uninterrupted wireless service for a user device.

Also, according to an example implementation, some control signals/messages, e.g., for connection management, may typically be sent separately for each connection or cell within a MC session, such as messages for handover or cell reselection and resource scheduling messages, as examples. That is, at least some control messages for each connection are communicated over the respective connection. For example, according to an example implementation, a BS providing a first connection with a user device may send a transmission schedule for the first connection over the first connection to the user device. Similarly, handover messages and/or cell reselection messages for a first connection may be sent between a user device and a base station via the first connection.

Referring to FIG. 2, core network 150 may include, for example, a multiple connection (MC) anchor 252 which may perform core network functions associated with establishing, management and/or control of one or more multiple connection (MC) sessions, such as, for example, for a MC session that may be established between user device 131 and core network 150.

According to an example implementation, a data unit (or packet) numbering may be provided at a layer or entity above the PDCP entity, e.g., to allow a common set of data unit sequence numbers to be applied or used for all data units among the multiple connections/cells within a MC session. For example, in the downlink direction towards the user device 131, MC anchor 252 may receive data packets (or data units) for the MC session, provide or add a MC session sequence number to each data unit, duplicate each of the data units (for transmission to multiple cells/BSs of the MC session), and forward or send all of the data units for the MC session to each cell or BS providing a connection to the user device for the MC session. In the uplink direction (data from the user device to the core network) for the MC session, the MC anchor 252 may receive one or more data units from each of the cells (but, in an example implementation, typically not receive the same data unit from multiple cells) for the MC session, may reorder the received data units as necessary based on a MC session sequence number for each MC session data unit, and then may forward the data units via the Internet or other data network.

In an example implementation, each cell (or BS providing the cell) that is part of the MC session (or each cell/BS that provides a connection of the MC session), may receive and store all the downlink data units of the MC session from the MC anchor 252. Therefore, according to an example implementation, duplicate data streams for the MC session may be transmitted from MC anchor 252 to each BS/cell (or via each connection) of the MC session, e.g., to both BS 144/cell 146 and to BS 134/cell 136. In an example implementation, the user device 131 may send a data request(s) to each cell/BS of the MC session requesting to receive one or more data units (or a group of data units) of the MC session from the cell. User device 131 may send a request to receive data unit(s) to each of the BSs/cells of the MC session, although the user device 131 may typically request (and receive) different data units of the MC session from each BS/cell/connection of the MC session. Thus, according to an example implementation, user device 131 may request and receive different groups of data units from each cell/BS/connection of the MC session. For example, user device 131 may send to cell 146/BS 144 a request to receive all odd-numbered (e.g., based on MC session sequence numbers) data units from cell 146 for the MC session, and user device 131 may send to cell 136/BS 134 a request to receive all even-numbered (e.g., based on MC session sequence numbers) data units from cell 136 for the MC session. This is just an example, and user device 131 may request any data units from the cells of the MC session.

According to an example implementation, each cell of a MC session may receive all the data units or packets of a MC session, including the data units to be transmitted by the cell, as well as the other data units to be transmitted (or requested by the user device for transmission) by other cells of the MC session. Therefore, according to an example implementation, duplicate downlink data streams (including all data units of the MC session) may be sent by MC anchor 252 to all cells of (or assigned to) the MC session. Also, according to an example implementation, the user device 131 may request any data unit from any of the cells/BSs/connections of the MC session, e.g., because all of the downlink data units of the MC session may be received and stored by each of the cells/BSs of the MC session. This may allow, for example, a splitting of downlink traffic (data units) of the MC session to the user device, e.g., where different types of traffic (e.g., data, voice) may be sent over different connections/cells, or where traffic may be allocated to one or more of the connections/cell of the MC session based on one or more criteria, such as a quality of service requested by each application using the MC session, a channel quality (e.g., packet error rate, received signal strength) of each wireless connection, etc. For example, a user device may measure a signal strength of each connection, and may request more (or a greater percentage) of data units of the MC session to be received from connections/cells having greater signal strength or lower error rate, etc., and may request less or fewer of the data units of the MC session to be received via connections/cells having a lower signal strength or higher error rate, for example.

In response to receiving one or more data units, the user device 131 may send one or more acknowledgements to one or more cells of the MC session to acknowledge receiving one or more of the data unit(s). Various techniques or implementations may be used for communication of acknowledgements. For example, the user device 131 may send an acknowledgement(s) to cell 146 that acknowledges both data units received from cell 146 and data units received from other cells (e.g., cell 136) of the MC session. Thus, if user device 131 receives all odd-numbered data units (for example) from cell 146 for the MC session and receives all even-numbered data units from cell 136, then, according to one example implementation, the user device 131 may send acknowledgements to both cells 146 and 136 that acknowledges receipt of both odd and even numbered data units. In this manner, by notifying each cell of the MC session of any received data unit (including data unit received from a different cell), the cell may discard or delete any data unit that was received by the user device 131. An acknowledgement may be provided as a first acknowledgement that acknowledges only data units transmitted by the receiving cell and a second (separate) acknowledgement (cross-cell acknowledgement) that acknowledges data units received by other cells. Or, alternatively, the acknowledgements for data units from all cells of the MC session may be combined. Also, acknowledgements sent by the user device 131 to a cell may be piggy-backed onto a data request sent to the cell. For example, a request sent by user device 131 to cell 146 to receive one or more data units from cell 146 may also include a piggy-backed acknowledgement that acknowledges that the user device 131 has received one or more other data units (received from either cell 146 or cell 136).

In another example implementation, the user device 131 may send an acknowledgement(s) to each cell to acknowledge (e.g., only) data received from such cell, and then each cell may send a message (e.g., via X2 interface or BS-to-BS interface) to the other cells/BSs of the MC session to identify the data units that have been received by the user device (e.g., based on the acknowledgement(s) received by the cell from the user device 131). Therefore, cross-cell acknowledgements (e.g., acknowledging receipt of data units from other cells) may be communicated by the user device 131, or by one or more of the cells via a BS-to-BS (or cell-to-cell) interface or communications link, for example.

Some illustrative examples will now be described regarding the operation of the user device 131, the base stations (BSs) of (or assigned to) a MC session, and the MC anchor 252. Referring to FIG. 2, user device 131 may, for example, first establish a connection 260 via cell 146/BS 144 to core network 150, and then may then establish a connection 262 via cell 136/BS 134 to core network 150. User device 131 may be assigned an ID (or identifier) that may identify the user device within each of cells 146 and 136. Thus, in this example, the user device 131 may include two identifiers. User device 131 may send a multiple connection (MC) session setup request message to MC anchor 252 via one (or both) of the connections 260 or 262 (or via cell 146 or 136), to request that the MC anchor 252 establish or setup a MC session between the user device 131 and core network 150 via the two identified connections 260, 262, or via the two identified cells 146 and 136, for example.

According to an example implementation, the MC session setup request message may include one or more fields, such as a field indicating MC session setup request, cell IDs to identify the cells 146 and 136 that are to be added (or included in) the MC session, and/or a user device identifier (e.g., a mobile station ID or MSID) identifying the user device for or within each of cells 136 and 146, as examples. After establishing the MC session, MC anchor 152 may send a MC session setup reply message to user device 131 via one or more (or both) of the connections 260, 262 indicating that the MC session has been established, and may identify a MC session ID (MC session identifier). For downlink data units addressed to directed to the user device 131, MC anchor 152 may add a MC session sequence number (e.g., above the PDCP layer) to each data unit, and then send duplicate data units (duplicate data streams) to each of the cells/connections (cell 146/BS 144, and cell 136/BS 134) of (or assigned to) the MC session. The downlink data units of the MC session are received and stored by both cells/BSs (cell 146/BS 144 and cell 136/BS 134).

The user device 131 may send a message to each of the cells (cell 136/BS 134 and cell 146/BS 144) of the MC session to identify one or more (or a group) data units of the MC session that the user device 131 is requesting to receive from the cell/BS. Alternatively, the core network 150 may determine and may notify each BS/cell of the MC session of which data units, or what portion or percentage of the data units, of the MC session should be sent to the user device 131.

The user device 131 or the core network may use or take into account various criteria or approaches to determine which data units or what portion of the data units should be allocated to (or sent from) each of the cells/BSs of the MC session, such as, for example, equal traffic load balancing among the connections/cells, allocating traffic among cells or connections based on channel quality or radio path conditions (e.g., received signal strength or error rate) of each connection, a traffic load on each cell or BS, priority of each data unit or of different types of traffic included in the MC session, etc. User device 131 may send acknowledgements to the cells 136 and 146 as described above. Cross-cell acknowledgements (e.g., acknowledging, to a cell, of receipt of a data unit received from another cell of the MC session) may be sent directly by the user device 131 to the cells, or may be forwarded by a cell/BS that transmitted the data unit to other cells of the MC session, for example.

In the uplink direction, the user device 131 may add a MC session sequence number to each data unit, and may forward each data unit of the MC session to one of the cells of the MC session. The same or similar criteria or conditions may be used by the user device 131 to determine how to allocate uplink data units among two or more connections/cells for a MC session, e.g., based on traffic load balancing among multiple connections/cells, allocating traffic among the multiple connections/cells based on channel quality or radio path conditions, etc. Each cell may receive and forward received data units to core network 150, where MC anchor 152 may re-order received data units into a correct order based on the MC session sequence numbers of the received data units.

Therefore, according to an example implementation, in the downlink direction, each cell or BS of the MC session may receive all data units or a duplicate data stream from the MC anchor 152, where the data units sent to both/all cells/BSs of the MC session use or provide a common sequence numbering system, and where only one cell/BS of the MC session typically sends or transmits each data unit to the user device 131 (e.g., based on a request from the user device or based on instructions from the core network). However, in some cases, a cell/BS may be requested to retransmit a data unit that was not successfully received/decoded by the user device 131 from another cell/BS. According to an example implementation, in the uplink direction, the user device 131 may add a MC session sequence number to each data unit, and then transmit or send each data unit to one of the cells/BSs of the MC session. Thus, according to an example implementation, duplicate data streams (or all data units) of the MC session are provided from MC anchor 252 to all cells of the MC session for downlink data, but not for uplink data of the MC session.

Referring to FIG. 2, user device 131 may move away from cell 146 and towards cell 156, as shown by arrow 270. As the user device 131 moves, for example, one of a plurality of conditions may be detected by the user device 131 with respect to cell 146 that may cause the user device 131 to re-allocate one or more data units of the MC session that were scheduled (or requested) for transmission from cell 146 to user device 131 to be re-assigned or re-allocated to cell 136 (or re-assigned or re-allocated for transmission from cell 136 or other cell(s) to user device 131). For example, one or more of the following conditions may be detected by user device 131: a radio link failure of the wireless connection 260A (or a detection of a failure of the wireless connection 260A), detecting that a signal quality (e.g., received signal strength) of the wireless signal for the wireless connection 260A (associated with cell 146) is less than a threshold, detecting that one or more data units sent/transmitted by cell 146 were not decoded by user device 131 (e.g., due to signal interference), a handover condition detected with respect to cell 146 (e.g., a received signal strength of a signal from cell 156 is greater than a received signal strength from cell 146, indicating to user device 131 that a handover may or should be performed from cell 146 to cell 156) (where such handover condition may be reported to core network 150 to allow core network 150 to make handover decision for user device, or user device 131 may make its own handover decision), a decision by user device 131 or core network 150 to perform a handover of connection 260 from cell 146 to cell 156, and/or other detected condition or situation. These are merely some examples and other conditions or situations may be used to trigger or cause user device to re-allocate or re-assign the transmission of one or more data units from cell 146 to one or more other cells, e.g., to cell 136 or other cell.

In response to user device 131 detecting one or more of the above-noted example conditions, user device 131 may identify one or more requested but missing data units with respect to cell 146, which, e.g., may include data units that were requested from cell 146 but not yet received/decoded by user device 131. User device 131, in response to detecting one or more of the above-noted conditions (as examples) may send a re-allocation message to cell 136/BS 134 that requests the cell 136 to send/transmit one or more (or all) of the missing data units of the MC session to user device 131. Note, that an acknowledgment of receipt of such missing data unit(s) of the MC session would not yet have been sent to cell 136 because such missing data units have not yet been received by user device 131. Therefore, according to an example implementation, cell 136/BS 134 should still have stored in buffer or memory the one or more missing data units of the MC session, and these may then be transmitted from cell 136 to user device 131 upon request from user device 131. For example, if user device 131 had originally requested odd-numbered data units from cell 146/BS 144 and a last acknowledged odd-numbered data unit was sequence number 235, then upon detecting one of the above-noted conditions, user device 131 may send a request to cell 136/BS 134 to also send odd-numbered data units, or a request to send data units 237, 239, 241, etc. (the next odd-numbered data units). Alternatively, user device 131 may simply send, for example, a request to cell 136/BS 134 to send all data units (not merely even-numbered data units) of the MC session to user device 131, which would cause cell 136/BS 134 to send any missing or next in-sequence odd-numbered data units of the MC session that were previously scheduled or allocated to cell 146 for transmission to user device 131.

As an example, in response to detecting that one or more data units sent/transmitted by cell 146 were not decoded by user device 131, user device may send a request to the other cell of the MC session (cell 136/BS 134) to send the one or more data unit that were not received or decoded by the user device. User device 131 may also send a message to cell 136/BS 134 to request one or more additional data units that generally were requested for transmission from cell 146, e.g., odd-numbered data units, since user device 131 may assume (e.g., based on the detected condition or failure to decode one or more data units) that the connection 260 is unreliable. Therefore, user device 131 may send a request to cell 146 to disconnect user device 131 from cell 146 via connection 260A. Also, user device 131 may, from time to time, send a connection add message (to request MC anchor 151 to add a connection to a MC session) and/or a connection drop message (to request MC anchor 252 to drop a connection from a MC session) to MC anchor 252. Thus, in this example, user device 131, based on the detected condition, may send a connection drop message to MC anchor 252 to request MC anchor to drop connection 260/cell 146 from the MC session. Based on this connection drop message, the MC anchor 252 may drop connection 260, causing MC anchor 252 to cease (or no longer) send data units for the MC session to the cell 146/BS 144, for example. In such example, downlink data units for the MC session may (at least temporarily) be sent by MC anchor 252 only to cell 136/BS 134, since connection 260/cell 146 has been dropped or deleted from the MC session.

At some point, user device 131 may establish a connection 264 (including wireless connection 264A and backhaul connection 264B) to core network 150 via cell 156/BS 154. User device may, for example, then send to MC anchor 252 a connection add message to request MC anchor 252 to add connection 264/cell 156/BS 154 to the MC session. MC anchor 252 may then send a copy of the data units for the MC session to both cell 136 and (newly added) cell 156. After receiving a reply confirming that the connection 264 has been added to the MC session, user device 131 may send a message to cell 156/BS 154 requesting to receive one or more data units of the MC session, e.g., to receive odd-numbered data units of the MC session beginning with a specific sequence number that may be provided in the message. User device 131 may also send a message to cell 136/BS 134 requesting (going forward) only data units with specific sequence numbers, e.g., only data units with even-numbered sequence numbers. In this manner, the MC session, which may include two or more of the independent connections 260, 262 and 264 (including independent wireless connections 260A, 262A and 264A), uninterrupted wireless service may be provided to user device 131, even though a radio link failure or other problem occurred in one of the connections. Therefore, in an illustrative example, after a radio link failure or other issue was detected with connection 260A, the data units of the MC session that had been scheduled or allocated for transmission by cell 146/cell 144 to user device 131 may be re-assigned or re-allocated to one or more remaining connections of the MC session, e.g., to connection 262/cell 136/BS 134, e.g., until another connection 264 may be established and added to the MC session. This is merely one illustrative example, and other implementations or examples may be used. Thus, the example implementations may provide improved robustness of wireless service to a user device.

According to another example implementation, user device 131 may detect a handover condition with respect to connection 260A/cell 146 (e.g., determining that a received signal strength of a signal from cell 156 is greater than a received signal strength from cell 146, indicating to user device 131 that a handover may or should be performed from cell 146 to cell 156), or otherwise user device 131 or core network 150 makes a decision to perform a handover of connection 260 from cell 146 to cell 156. In such a case, while the handover is being performed from cell 146 to cell 156, all data units may be transmitted by one or more or even all remaining cells of the MC session (e.g., cell 136 in this example) to user device 131. According to an example implementation, as part of the handover, there is no need for cell 146/BS 144 to forward untransmitted buffered packets/data units to cell 136/BS 134 or to cell 156/cell 154, because cell 136 already has stored or buffered all the received but untransmitted (e.g., unacknowledged) data units, and cell 136 can at least temporarily handle the transmission of data units that were originally allocated to cell 146 for transmission, until the handover from cell 146 to cell 156 is complete. In this manner, by not requiring a target cell (e.g., cell 156) to wait for buffered packets to arrive from a source cell (e.g., cell 146) before completing the handover from source cell to target cell, a handover may be performed more quickly, or with less delay or latency.

Thus, according to an example implementation, a multiple connection session may include at least two connections, e.g., which may include two independent wireless connections, such as a first independent wireless connection to a first cell and a second independent wireless connection to a second cell. According to an example implementation, the user device may receive from the first cell a first message identifying one or more data units of the multiple connection session that are stored by the first cell and available for delivery from the first cell to the user device. The user device may similarly receive from the second cell a second message identifying one or more data units of the multiple connection session that are stored by the second cell and available for delivery from the second cell to the user device. The user device may determine which data units of the multiple connection session to receive from each of the cells, but each data unit is typically transmitted from only one of the cells/connections of the multiple connection session.

In addition, the user device may monitor various conditions associated with each connection, such as, e.g., channel quality (e.g., received signal strength, error rate . . . ) of each wireless connection, and may monitor signals from other cells. A handover condition may be reported from the user device (e.g., indicating a received signal of a third cell that is stronger than the signal from the first cell), and the core network may make a decision or determination for the user device to perform a handover or cell reselection. In an alternative embodiment, the user device may determine when and to what target cells the user device will perform handover for each cell or connection of a multiple connection session.

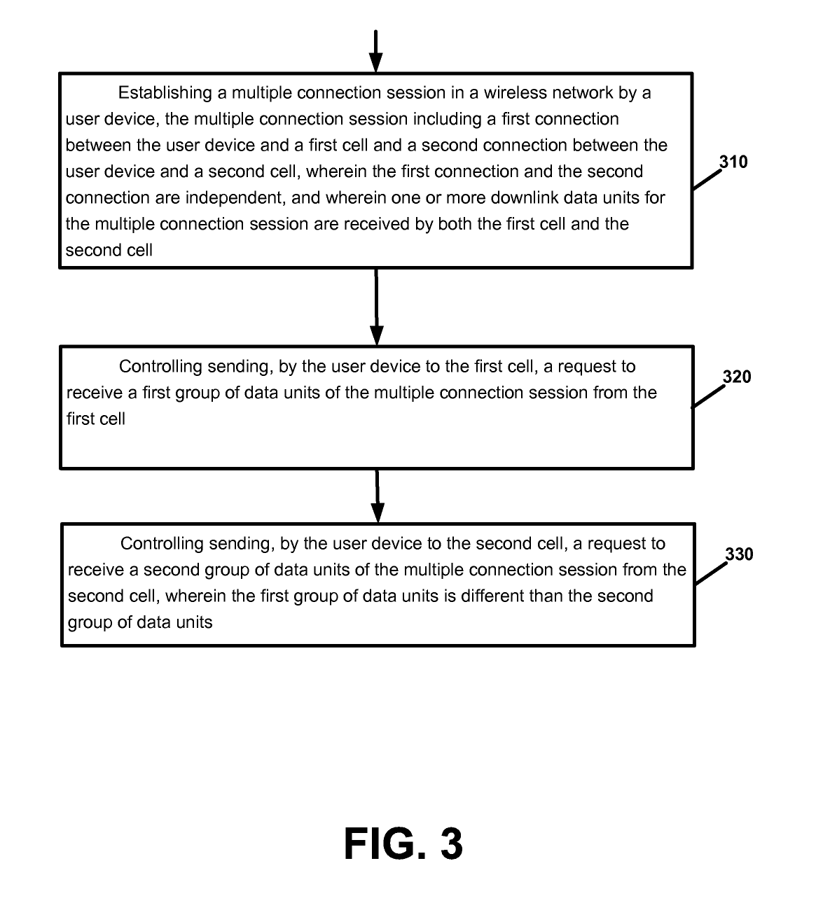

FIG. 3 is a flow chart illustrating operation of a user device according to an example implementation. Operation 310 includes establishing a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell. Operation 320 includes controlling sending, by the user device to the first cell, a request to receive a first group of data units of the multiple connection session from the first cell. And, operation 330 includes controlling sending, by the user device to the second cell, a request to receive a second group of data units of the multiple connection session from the second cell, wherein the first group of data units is different than the second group of data units.

According to an example implementation, the method illustrated in FIG. 3 may further include making a determination by the user device of which data units of the multiple connection session should be received via the first cell and which data units of the multiple connection session should be received via the second cell.

According to an example implementation, the method illustrated in FIG. 3 may further include making a decision by the user device to perform a handover of the first connection from the first cell to a third cell while data for the multiple connection session is communicated via the second cell.

According to an example implementation, the method illustrated in FIG. 3 may further include making a decision by the user device to perform a handover of the second connection from the second cell to a fourth cell while data for the multiple connection session is communicated via the third cell.

According to an example implementation, the method illustrated in FIG. 3 may further include making a decision by a core network to perform a handover of the first connection from the first cell to a third cell while data for the multiple connection session is communicated via the second cell.

According to an example implementation, the method illustrated in FIG. 3 may further include controlling receiving, from the first cell, a first message identifying one or more data units of the multiple connection session that are available at the first cell for delivery to the user device, and wherein the controlling sending, by the user device to the first cell, a request to receive a first group of data units includes controlling sending, by the user device to the first cell, a request to receive one or more of the data units that are available at the first cell.

According to an example implementation, the method illustrated in FIG. 3 may further include controlling receiving, from the second cell, a second message identifying one or more data units of the multiple connection session that are available at the second cell for delivery to the user device, and wherein the controlling sending, by the user device to the second cell, a request to receive a second group of data units includes controlling sending, by the user device to the second cell, a request to receive one or more of the data units that are available at the second cell.

According to an example implementation, the method illustrated in FIG. 3 may further include controlling receiving, by the user device, at least some of the first group of data units from a multiple connection entity of a core network via the first cell and the first connection, controlling receiving, by the user device, at least some of the second group of data units from the multiple connection entity via the second cell and the second connection, and re-ordering, by the user device, one or more of the received data units.

According to an example implementation, the method illustrated in FIG. 3 may further include controlling sending, from the user device to the first cell, an acknowledgement that acknowledges receiving one or more data units of the first group of data units and one or more data units of the second group of data units.

According to an example implementation, the controlling sending an acknowledgement may include: controlling sending, from the user device to the first cell, a first message that acknowledges receiving one or more data units of the first group of data units, and controlling sending, from the user device to the first cell, a second message that acknowledges receiving one or more data units of the second group of data units.

According to an example implementation, the method illustrated in FIG. 3 may further include controlling sending, from the user device to the second cell, an acknowledgement that acknowledges receiving one or more data units of the first group of data units and one or more data units of the second group of data units.

According to an example implementation, the method illustrated in FIG. 3 may further include controlling sending, from the user device to the second cell, a first acknowledgement that acknowledges that the user device has received one or more data units of the second group of data units, and controlling sending, from the second cell or a core network to the first cell, a second acknowledgement that acknowledges that the user device has received the one or more data units of the second group of data units.

According to an example implementation, the method illustrated in FIG. 3 may further include detecting, by the user device, a condition associated with the first cell, and controlling sending, by the user device to the second cell in response to detecting the condition, a request to receive at least some of the first group of data units from the second cell.

In an example implementation, the condition may include at least one of the following: a signal quality of a signal received by the user device from the first cell that is below a threshold, a failure, detected by the user device, of the first connection between the user device and the first cell, a decision by either the user device or a core network to perform a handover or cell reselection from the first cell to a third cell, and a decision by either the user device or a core network to perform a connection re-establishment to the first cell.

According to an example implementation, the method illustrated in FIG. 3 may further include detecting an error condition associated with the first cell, and controlling sending, from the user device to the second cell, a request to retransmit one or more data units of the first group of data units from the second cell.

According to an example implementation, the method illustrated in FIG. 3 may further include detecting a condition associated with the first cell, controlling sending, by the user device to the second cell, a request to receive at least some of the first group of data units from the second cell, performing a handover or cell reselection for the first connection from the first cell to a third cell while the second cell sends all data of the multiple connection session to the user device, and controlling sending, by the user device to the third cell after handover or cell reselection to the third cell is completed, a request to receive a third group of data units of the multiple connection session.

According to an example implementation, an apparatus may include at least one processor and at least one memory including computer instructions, when executed by the at least one processor, cause the apparatus to: establish a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell, control sending, by the user device to the first cell, a request to receive a first group of data units of the multiple connection session, and control sending, by the user device to the second cell, a request to receive a second group of data units of the multiple connection session, wherein the first group of data units is different than the second group of data units.

According to an example implementation, the computer instructions, when executed by the at least one processor, further cause the apparatus to detect, by the user device, a condition associated with the first cell, and control sending, by the user device to the second cell in response to detecting the condition, a request to receive at least some of the first group of data units from the second cell.

According to an example implementation, the condition may include at least one of the following: a signal quality of a signal received by the user device from the first cell that is below a threshold, a failure, detected by the user device, of the first connection between the user device and the first cell, a decision by either the user device or a core network to perform a handover or cell reselection from the first cell to a third cell, and a decision by either the user device or a core network to perform a connection re-establishment to the first cell.

According to an example implementation, a computer program product may include a computer-readable storage medium and storing executable code that, when executed by at least one data processing apparatus, is configured to cause the at least one data processing apparatus to perform a method including: establishing a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell, controlling sending, by the user device to the first cell, a request to receive a first group of data units of the multiple connection session, and controlling sending, by the user device to the second cell, a request to receive a second group of data units of the multiple connection session, wherein the first group of data units is different than the second group of data units.

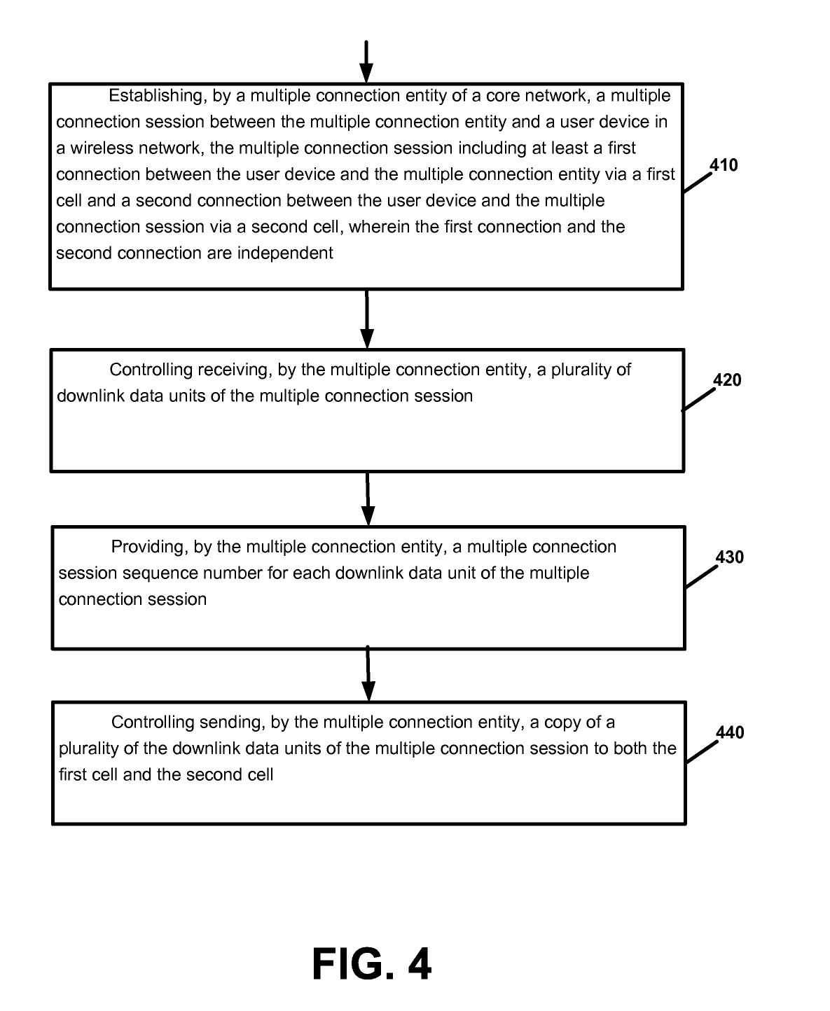

FIG. 4 is a flow chart illustrating operation of a multiple connection anchor at a core network according to an example implementation. Operation 410 may include establishing, by a multiple connection entity of a core network, a multiple connection session between the multiple connection entity and a user device in a wireless network, the multiple connection session including at least a first connection between the user device and the multiple connection entity via a first cell and a second connection between the user device and the multiple connection session via a second cell, wherein the first connection and the second connection are independent. Operation 420 may include controlling receiving, by the multiple connection entity, a plurality of downlink data units of the multiple connection session. Operation 430 may include providing, by the multiple connection entity, a multiple connection session sequence number for each downlink data unit of the multiple connection session. And, operation 440 may include controlling sending, by the multiple connection entity, a copy of a plurality of the downlink data units of the multiple connection session to both the first cell and the second cell.

According to an example implementation, in the method of FIG. 4, the controlling sending may include controlling sending a copy of all of the downlink data units of the multiple connection session to both the first cell and the second cell while the multiple connection session is configured to include the first cell and the second cell.

According to an example implementation, the method of FIG. 4 may further include performing the following after of the user device has performed a handover or cell reselection from the first cell to a third cell for the first connection of the multiple connection session: discontinuing, by the multiple connection entity, controlling sending downlink data units for the multiple connection session to the first cell, and controlling, by the multiple connection entity, sending a copy of at least some of the downlink data units of the multiple connection session to the third cell based upon a request from the third cell.

According to an example implementation, in the method of FIG. 4, each of the downlink data units of the multiple connection session are forwarded from either the first cell or the second cell to the user device based upon one or more requests from the user device.

According to an example implementation, the method of FIG. 4 may further include controlling receiving, by the multiple connection entity, one or more uplink data units of the multiple connection session from the user device sent via the first cell and one or more uplink data units of the multiple connection session from the user device sent via the second cell, each of the received uplink data units including a multiple connection session sequence number, and re-ordering, by the multiple connection entity, the received uplink data units based on the multiple connection session sequence number for each of the received data units.

According to an example implementation, in the method of FIG. 4 the first connection may include a first wireless connection between the user device and the first cell and a first backhaul connection between the first cell and the multiple connection entity, and the second connection may include a second wireless connection between the user device and the second cell and a second backhaul connection between the second cell and the multiple connection entity.

According to an example implementation, an apparatus may include at least one processor and at least one memory including computer instructions, when executed by the at least one processor, cause the apparatus to: establish, by a multiple connection entity of a core network, a multiple connection session between the multiple connection entity and a user device in a wireless network, the multiple connection session including at least a first connection between the user device and the multiple connection entity via a first cell and a second connection between the user device and the multiple connection session via a second cell, wherein the first connection and the second connection are independent, control receiving, by the multiple connection entity, a plurality of downlink data units of the multiple connection session, provide, by the multiple connection entity, a multiple connection session sequence number for each downlink data unit of the multiple connection session, and control sending, by the multiple connection entity, a copy of a plurality of the downlink data units of the multiple connection session to both the first cell and the second cell.

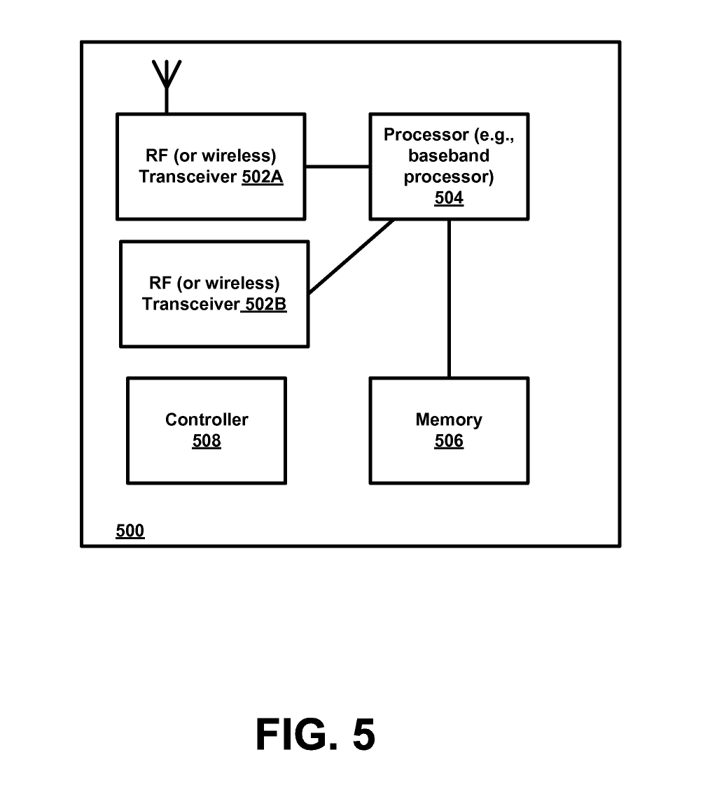

According to an example implementation, a computer program product (such as, for example, a memory 506, FIG. 5) for a computer may include software code portions for performing the steps of any of the example implementations, methods or steps described herein, including for performing the methods described in either of FIGS. 3 and 4 and/or for performing the further example implementations described based on the methods of FIG. 3 or 4, or for performing any of the method claims listed below, when the software code portions of the computer program product are run on the computer.

FIG. 5 is a block diagram of a wireless station (e.g., BS or user device) 500 according to an example implementation. The wireless station 500 may include, for example, two RF (radio frequency) or wireless transceivers 502A, 502B, where each wireless transceiver includes a transmitter to transmit signals and a receiver to receive signals. The wireless station also includes a processor or control unit/entity (controller) 504 to execute instructions or software and control transmission and receptions of signals, and a memory 506 to store data and/or instructions.

Processor 504 may also make decisions or determinations, generate frames, packets or messages for transmission, decode received frames or messages for further processing, and other tasks or functions described herein. Processor 504, which may be a baseband processor, for example, may generate messages, packets, frames or other signals for transmission via wireless transceiver 502 (502A or 502B). Processor 504 may control transmission of signals or messages over a wireless network, and may control the reception of signals or messages, etc., via a wireless network (e.g., after being down-converted by wireless transceiver 502, for example). Processor 504 may be programmable and capable of executing software or other instructions stored in memory or on other computer media to perform the various tasks and functions described above, such as one or more of the tasks or methods described above. Processor 504 may be (or may include), for example, hardware, programmable logic, a programmable processor that executes software or firmware, and/or any combination of these. Using other terminology, processor 504 and transceiver 502 together may be considered as a wireless transmitter/receiver system, for example.

In addition, referring to FIG. 5, a controller (or processor) 508 may execute software and instructions, and may provide overall control for the station 500, and may provide control for other systems not shown in FIG. 5, such as controlling input/output devices (e.g., display, keypad), and/or may execute software for one or more applications that may be provided on wireless station 500, such as, for example, an email program, audio/video applications, a word processor, a Voice over IP application, or other application or software.

In addition, a storage medium may be provided that includes stored instructions, which when executed by a controller or processor may result in the processor 504, or other controller or processor, performing one or more of the functions or tasks described above.

According to another example implementation, RF or wireless transceiver(s) 502A/502B may receive signals or data and/or transmit or send signals or data. Processor 504 (and possibly transceivers 502A/502B) may control the RF or wireless transceiver 502A or 502B to receive, send, broadcast or transmit signals or data.

An example of an apparatus may also include means (504, 502A/502B) for establishing a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell, means (504, 502A/502B) for controlling sending, by the user device to the first cell, a request to receive a first group of data units of the multiple connection session from the first cell, and means (504, 502A/502B) for controlling sending, by the user device to the second cell, a request to receive a second group of data units of the multiple connection session from the second cell, wherein the first group of data units is different than the second group of data units.

According to an example implementation, the apparatus may further include means (504) for making a determination by the user device of which data units of the multiple connection session should be received via the first cell and which data units of the multiple connection session should be received via the second cell.

According to an example implementation, the apparatus may further include means (504) for making a decision by the user device to perform a handover of the first connection from the first cell to a third cell while data for the multiple connection session is communicated via the second cell.

According to an example implementation, the apparatus may further include means (504) for making a decision by the user device to perform a handover of the second connection from the second cell to a fourth cell while data for the multiple connection session is communicated via the third cell.

According to an example implementation, the apparatus may further include means (504) for making a decision by a core network to perform a handover of the first connection from the first cell to a third cell while data for the multiple connection session is communicated via the second cell.

According to an example implementation, the apparatus may further include means (504, 502A/502B) for controlling receiving, from the first cell, a first message identifying one or more data units of the multiple connection session that are available at the first cell for delivery to the user device, and wherein the means (504, 502A/502B) for controlling sending, by the user device to the first cell, a request to receive a first group of data units includes means (504, 502A/502B) for controlling sending, by the user device to the first cell, a request to receive one or more of the data units that are available at the first cell.

According to an example implementation, the apparatus may further include means (504, 502A/502B) for controlling receiving, from the second cell, a second message identifying one or more data units of the multiple connection session that are available at the second cell for delivery to the user device, and wherein the means (504, 502A/502B) for controlling sending, by the user device to the second cell, a request to receive a second group of data units includes means (504, 502A/502B) for controlling sending, by the user device to the second cell, a request to receive one or more of the data units that are available at the second cell.

According to an example implementation, the apparatus may further include means (504, 502A/502B) for controlling receiving, by the user device, at least some of the first group of data units from a multiple connection entity of a core network via the first cell and the first connection, means (504, 502A/502B) for controlling receiving, by the user device, at least some of the second group of data units from the multiple connection entity via the second cell and the second connection, and means (504, 502A/502B, 506) for re-ordering, by the user device, one or more of the received data units.

According to an example implementation, the apparatus may further include means (504, 502A/502B) for controlling sending, from the user device to the first cell, an acknowledgement that acknowledges receiving one or more data units of the first group of data units and one or more data units of the second group of data units.

According to an example implementation, the means (504, 502A/502B) for controlling sending an acknowledgement may include: means (504, 502A/502B) for controlling sending, from the user device to the first cell, a first message that acknowledges receiving one or more data units of the first group of data units, and means (504, 502A/502B) for controlling sending, from the user device to the first cell, a second message that acknowledges receiving one or more data units of the second group of data units.

According to an example implementation, the apparatus may further include means (504, 502A/502B) for controlling sending, from the user device to the second cell, an acknowledgement that acknowledges receiving one or more data units of the first group of data units and one or more data units of the second group of data units.

According to an example implementation, the apparatus may further include means (504, 502A/502B) for controlling sending, from the user device to the second cell, a first acknowledgement that acknowledges that the user device has received one or more data units of the second group of data units, and controlling sending, from the second cell or a core network to the first cell, a second acknowledgement that acknowledges that the user device has received the one or more data units of the second group of data units.

According to an example implementation, the apparatus may further include means (504, 502A/502B) for detecting, by the user device, a condition associated with the first cell, and means (504, 502A/502B) for controlling sending, by the user device to the second cell in response to detecting the condition, a request to receive at least some of the first group of data units from the second cell.

In an example implementation, the condition may include at least one of the following: a signal quality of a signal received by the user device from the first cell that is below a threshold, a failure, detected by the user device, of the first connection between the user device and the first cell, a decision by either the user device or a core network to perform a handover or cell reselection from the first cell to a third cell, and a decision by either the user device or a core network to perform a connection re-establishment to the first cell.

According to an example implementation, the apparatus may further include means (504, 502A/502B) for detecting an error condition associated with the first cell, and controlling sending, from the user device to the second cell, a request to retransmit one or more data units of the first group of data units from the second cell.

According to an example implementation, the apparatus may further include means (504, 502A/502B) for detecting a condition associated with the first cell, controlling sending, by the user device to the second cell, a request to receive at least some of the first group of data units from the second cell, means (504, 502A/502B) for performing a handover or cell reselection for the first connection from the first cell to a third cell while the second cell sends all data of the multiple connection session to the user device, and means (504, 502A/502B) for controlling sending, by the user device to the third cell after handover or cell reselection to the third cell is completed, a request to receive a third group of data units of the multiple connection session.

Another example of an apparatus may include means (504, 502A/502B) for establishing, by a multiple connection entity of a core network, a multiple connection session between the multiple connection entity and a user device in a wireless network, the multiple connection session including at least a first connection between the user device and the multiple connection entity via a first cell and a second connection between the user device and the multiple connection session via a second cell, wherein the first connection and the second connection are independent, means (504, 502A/502B) for controlling receiving, by the multiple connection entity, a plurality of downlink data units of the multiple connection session, means (504, 502A/502B) for providing, by the multiple connection entity, a multiple connection session sequence number for each downlink data unit of the multiple connection session, and means (504, 502A/502B) for controlling sending, by the multiple connection entity, a copy of a plurality of the downlink data units of the multiple connection session to both the first cell and the second cell.

According to an example implementation, the apparatus may further include means (504, 502A/502B) for performing the following after of the user device has performed a handover or cell reselection from the first cell to a third cell for the first connection of the multiple connection session, including: means (504, 502A/502B) for discontinuing, by the multiple connection entity, means (504, 502A/502B) for controlling sending downlink data units for the multiple connection session to the first cell, means (504, 502A/502B) for controlling, by the multiple connection entity, sending a copy of at least some of the downlink data units of the multiple connection session to the third cell based upon a request from the third cell.

According to an example implementation of the apparatus, each of the downlink data units of the multiple connection session may be forwarded from either the first cell or the second cell to the user device based upon one or more requests from the user device.

According to an example implementation, the apparatus may further include means (504, 502A/502B) for controlling receiving, by the multiple connection entity, one or more uplink data units of the multiple connection session from the user device sent via the first cell and one or more uplink data units of the multiple connection session from the user device sent via the second cell, each of the received uplink data units including a multiple connection session sequence number, and means (504, 502A/502B, 506) for re-ordering, by the multiple connection entity, the received uplink data units based on the multiple connection session sequence number for each of the received data units.

According to an example implementation of the apparatus, the first connection may include a first wireless connection between the user device and the first cell and a first backhaul connection between the first cell and the multiple connection entity, and the second connection may include a second wireless connection between the user device and the second cell and a second backhaul connection between the second cell and the multiple connection entity.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method including a processor configured to execute instructions to perform a method, the method comprising:
establishing a multiple connection session in a wireless network by a user device, the multiple connection session including a first connection between the user device and a first cell and a second connection between the user device and a second cell, wherein the first connection and the second connection are independent, and wherein one or more downlink data units for the multiple connection session are received by both the first cell and the second cell;
controlling sending, by the user device to the first cell, a request to receive a first group of data units of the multiple connection session from the first cell; and
controlling sending, by the user device to the second cell, a request to receive a second group of data units of the multiple connection session from the second cell, wherein the first group of data units is different than the second group of data units.

2. The method of claim 1 and further comprising:
making a determination by the user device of which data units of the multiple connection session should be received via the first cell and which data units of the multiple connection session should be received via the second cell.

3. The method of claim 1 and further comprising:
making a decision by the user device to perform a handover of the first connection from the first cell to a third cell while data for the multiple connection session is communicated via the second cell.

4. The method of claim 3 and further comprising:
making a decision by the user device to perform a handover of the second connection from the second cell to a fourth cell while data for the multiple connection session is communicated via the third cell.

5. The method of claim 1 and further comprising:
controlling receiving, from the first cell, a first message identifying one or more data units of the multiple connection session that are available at the first cell for delivery to the user device; and
wherein the controlling sending, by the user device to the first cell, a request to receive a first group of data units comprises controlling sending, by the user device to the first cell, a request to receive one or more of the data units that are available at the first cell.

6. The method of claim 1 and further comprising:
controlling receiving, from the second cell, a second message identifying one or more data units of the multiple connection session that are available at the second cell for delivery to the user device; and
wherein the controlling sending, by the user device to the second cell, a request to receive a second group of data units comprises controlling sending, by the user device to the second cell, a request to receive one or more of the data units that are available at the second cell.

7. The method of claim 1 and further comprising:
controlling receiving, by the user device, at least some of the first group of data units from a multiple connection entity of a core network via the first cell and the first connection;
controlling receiving, by the user device, at least some of the second group of data units from the multiple connection entity via the second cell and the second connection; and
re-ordering, by the user device, one or more of the received data units.

8. The method of claim 1 and further comprising:
controlling sending, from the user device to the first cell, an acknowledgement that acknowledges receiving one or more data units of the first group of data units and one or more data units of the second group of data units.

9. The method of claim 8 wherein the controlling sending an acknowledgement comprises:
controlling sending, from the user device to the first cell, a first message that acknowledges receiving one or more data units of the first group of data units; and
controlling sending, from the user device to the first cell, a second message that acknowledges receiving one or more data units of the second group of data units.

10. The method of claim 1 and further comprising:
controlling sending, from the user device to the second cell, an acknowledgement that acknowledges receiving one or more data units of the first group of data units and one or more data units of the second group of data units.

11. The method of claim 1 and further comprising:
controlling sending, from the user device to the second cell, a first acknowledgement that acknowledges that the user device has received one or more data units of the second group of data units; and
controlling sending, from the second cell or a core network to the first cell, a second acknowledgement that acknowledges that the user device has received the one or more data units of the second group of data units.

12. The method of claim 1 and further comprising:
detecting, by the user device, a condition associated with the first cell;
controlling sending, by the user device to the second cell in response to detecting the condition, a request to receive at least some of the first group of data units from the second cell.

13. The method of claim 12 wherein the condition comprises at least one of the following:
a signal quality of a signal received by the user device from the first cell that is below a threshold;
a failure, detected by the user device, of the first connection between the user device and the first cell;
a decision by either the user device or a core network to perform a handover or cell reselection from the first cell to a third cell; and
a decision by either the user device or a core network to perform a connection re-establishment to the first cell.

14. The method of claim 1 and further comprising:
detecting an error condition associated with the first cell; and
controlling sending, from the user device to the second cell, a request to retransmit one or more data units of the first group of data units from the second cell.

15. The method of claim 1 and further comprising:
detecting a condition associated with the first cell;
controlling sending, by the user device to the second cell, a request to receive at least some of the first group of data units from the second cell.
performing a handover or cell reselection for the first connection from the first cell to a third cell while the second cell sends all data of the multiple connection session to the user device; and
controlling sending, by the user device to the third cell after handover or cell reselection to the third cell is completed, a request to receive a third group of data units of the multiple connection session.

16. An apparatus comprising at least one processor and at least one memory including computer instructions, when executed by the at least one processor, cause the apparatus to:
establish a multiple connection session in a wireless network for a user device, the multiple connection session including a first connection between the user device and a first cell and a second connection between the user device and a second cell, wherein the first connection and the second connection are independent, and wherein one or more downlink data units for the multiple connection session are received by both the first cell and the second cell;
control sending, by the user device to the first cell, a request to receive a first group of data units of the multiple connection session; and
control sending, by the user device to the second cell, a request to receive a second group of data units of the multiple connection session, wherein the first group of data units is different than the second group of data units.

17. The apparatus of claim 16 wherein the computer instructions, when executed by the at least one processor, further cause the apparatus to:
detect, by the user device, a condition associated with the first cell;
control sending, by the user device to the second cell in response to detecting the condition, a request to receive at least some of the first group of data units from the second cell.

18. The method of claim 17 wherein the condition comprises at least one of the following:
a signal quality of a signal received by the user device from the first cell that is below a threshold;
a failure, detected by the user device, of the first connection between the user device and the first cell;
a decision by either the user device or a core network to perform a handover or cell reselection from the first cell to a third cell; and
a decision by either the user device or a core network to perform a connection re-establishment to the first cell.

19. A computer program product, the computer program product comprising a computer-readable storage medium and storing executable code that, when executed by at least one data processing apparatus, is configured to cause the at least one data processing apparatus to perform a method comprising:
establishing a multiple connection session in a wireless network for a user device, the multiple connection session including a first connection between the user device and a first cell and a second connection between the user device and a second cell, wherein the first connection and the second connection are independent, and wherein one or more downlink data units for the multiple connection session are received by both the first cell and the second cell;
controlling sending, by the user device to the first cell, a request to receive a first group of data units of the multiple connection session; and
controlling sending, by the user device to the second cell, a request to receive a second group of data units of the multiple connection session, wherein the first group of data units is different than the second group of data units.

20. A method including a processor configured to execute instructions to perform a method, the method comprising:
establishing, by a multiple connection entity of a core network, a multiple connection session between the multiple connection entity and a user device in a wireless network, the multiple connection session including at least a first connection between the user device and the multiple connection entity via a first cell and a second connection between the user device and the multiple connection session via a second cell, wherein the first connection and the second connection are independent;
controlling receiving, by the multiple connection entity, a plurality of downlink data units of the multiple connection session;
providing, by the multiple connection entity, a multiple connection session sequence number for each downlink data unit of the multiple connection session;
controlling sending, by the multiple connection entity, a copy of a plurality of the downlink data units of the multiple connection session to both the first cell and the second cell.

21. The method of claim 20 and further comprising:
performing the following after of the user device has performed a handover or cell reselection from the first cell to a third cell for the first connection of the multiple connection session:
discontinuing, by the multiple connection entity, controlling sending downlink data units for the multiple connection session to the first cell;
controlling, by the multiple connection entity, sending a copy of at least some of the downlink data units of the multiple connection session to the third cell based upon a request from the third cell.

22. The method of claim 20 wherein each of the downlink data units of the multiple connection session are forwarded from either the first cell or the second cell to the user device based upon one or more requests from the user device.

23. The method of claim 20 and further comprising:
controlling receiving, by the multiple connection entity, one or more uplink data units of the multiple connection session from the user device sent via the first cell and one or more uplink data units of the multiple connection session from the user device sent via the second cell, each of the received uplink data units including a multiple connection session sequence number; and
re-ordering, by the multiple connection entity, the received uplink data units based on the multiple connection session sequence number for each of the received data units.

24. The method of claim 20 and further comprising:
wherein the first connection comprises a first wireless connection between the user device and the first cell and a first backhaul connection between the first cell and the multiple connection entity; and
wherein the second connection comprises a second wireless connection between the user device and the second cell and a second backhaul connection between the second cell and the multiple connection entity.

25. An apparatus comprising at least one processor and at least one memory including computer instructions, when executed by the at least one processor, cause the apparatus to:
establish a multiple connection session between a multiple connection entity of a core network and a user device in a wireless network, the multiple connection session including at least a first connection between the user device and the multiple connection entity via a first cell and a second connection between the user device and the multiple connection session via a second cell, wherein the first connection and the second connection are independent;
control receiving, by the multiple connection entity, a plurality of downlink data units of the multiple connection session;
provide, by the multiple connection entity, a multiple connection session sequence number for each downlink data unit of the multiple connection session; and
control sending, by the multiple connection entity, a copy of a plurality of the downlink data units of the multiple connection session to both the first cell and the second cell.
